(19) United States
(12) Patent Application Publication
(10) Pub. No.: US 2004/0195731 A1
(43) Pub. Date: Oct. 7, 2004

(54) Glass fiber reinforced plastics

(76) Inventors: Thorsten Rische, Unna (DE); Jan Weikard, Odenthal-Erberich (DE); Thomas Feller, Solingen (DE); Erhard Luhmann, Bomlitz (DE); Karin Naujoks, Odenthal (DE)

Correspondence Address: BAYER POLYMERS LLC, 100 BAYER ROAD, PITTSBURGH, PA, 15205, US

(21) Appl. No.: 10/458,115

(22) Filed: Jun. 10, 2003

(30) Foreign Application Priority Data
Jun. 17, 2002 (DE) 10226933.5

(51) Int. Cl. B29C 31/00

(52) U.S. Cl. 264/488; 264/257

(57) ABSTRACT

A process for preparing glass fiber reinforced plastics using high-energy radiation. A sizing composition is applied to the glass fiber, and the curing mechanism of the sizing composition proceeds in a controlled way by the use of two crosslinking mechanisms which can be activated separately from one another. Aqueous UV-curing polyurethane dispersions containing few or no active hydrogen atoms are used in combination with water-dispersible or water-soluble blocked polyisocyanates.

### CROSS REFERENCE TO RELATED PATENT APPLICATION

The present application claims the right of priority under 35 U.S.C. § 119 (a)-(d) of German Patent Application No. 10226933.5, filed Jun. 17, 2002.

### BACKGROUND OF THE INVENTION

1. Field of the Invention

The invention relates to a novel process for preparing glass fiber reinforced plastics using high-energy radiation.

2. Description of the Related Art

Aqueous coating compositions based on polyurethane dispersions and blocked polyisocyanates are known. They are combined, for example, to give one-component coating compositions. Coating compositions of this kind are used, for example, in the sizing of glass fibers, for example, for glass fiber reinforced plastics. Following application to the glass fibers, first of all the water is removed. The resultant film (size) is crosslinked by deblocking and reacting at least some of the polyisocyanates present. A further reaction of the polyisocyanates present in the size takes place when the glass fibers are incorporated into plastics. One problem of this procedure is that the deblocking and reaction of polyisocyanates during sizing of the glass fiber and during incorporation into plastics are difficult to separate from one another, thus resulting in an operating uncertainty. It is therefore advantageous to use two curing mechanisms which can be activated independently of one another.

The combination of curing by photopolymerization in aqueous coating compositions comprising unsaturated acrylates and post-curing by deblocking of polyisocyanates and their crosslinking with polyols is known, for example, from the multicoat painting of automobiles. WO-A 01/23453 discloses UV radiation and also thermally curable aqueous polyurethane dispersions which contain both U-V-curable groups and blocked isocyanate groups. A disadvantage here are the usually monofunctional acrylate monomers used, of low molecular weight, which prevent the synthesis of high molecular weight dispersions. Furthermore, in order to attain adequate properties, in many cases what are known as reactive diluents, such as polyfunctional, low molecular weight acrylates with objectionable physiological properties in some cases, are added, which have the further effect of preventing initial physical drying of the coating.

### SUMMARY OF THE INVENTION

Accordingly, the present invention provides a novel process for preparing glass fiber reinforced plastics, where the curing mechanism of the sizing composition can proceed in a controlled way by virtue of two crosslinking mechanisms which can be activated separately from one another.

This object has been achieved through the use of aqueous UV-curing polyurethane dispersions containing few or no active hydrogen atoms in combination with water-dispersible or water-soluble blocked polyisocyanates.

The invention accordingly provides a process for preparing glass fiber reinforced plastics, characterized in that a sizing composition is applied to the glass fiber, the water is removed, this is followed by exposure to high-energy radiation and, in a second step, the coated glass fiber is introduced into the plastic and a thermal cure is carried out at from 150 to 300° C., with liberation of the polyisocyanate groups by deblocking.

The sizing composition used in the process of the invention comprises:

(I) at least one water-dispersible or water-soluble blocked polyisocyanate (A),

(II) at least one polyurethane (B) which contains free-radically polymerizable groups and from 0 to 0.53 mmol/g, preferably from 0 to 0.4 mmol/g, with particular preference from 0 to 0.25 mmol/g, of groups containing Zerevitinov-active hydrogen atoms, and

(III) an initiator (C) which is capable of initiating a free-radical polymerization.

For the purposes of the present invention, groups containing Zerevitinov-active hydrogen atoms are hydroxyl, primary or secondary amine or thiol groups.

### DETAILED DESCRIPTION OF THE INVENTION

In accordance with the invention the polyurethanes (B) are in the form of aqueous polyurethane dispersions, emulsions or solutions which are prepared by polyaddition of second precursor diisocyanates or polyisocyanates (component a) with isocyanate-reactive compounds (component (b1) to (b5)).

Suitable second precursor polyisocyanates (a) are aromatic, araliphatic, aliphatic or cycloaliphatic polyisocyanates. It is also possible to use mixtures of such polyisocyanates. Examples of suitable polyisocyanates are butylene diisocyanate, hexamethylene diisocyanate (HDI), isophorone diisocyanate (IPDI), 2,2,4 and/or 2,4,4-trimethylhexamethylene diisocyanate, the isomeric bis(4,4′-iso-cyanatocyclohexyl)methanes or their mixtures of any desired isomer content, isocyanatomethyl-1,8-octane diisocyanate, 1,4-cyclohexylene diisocyanate, 1,4-phenylene diisocyanate, 2,4- and/or 2,6-tolylene diisocyanate, 1,5-naphthylene diisocyanate, 2,4′- or 4,4′-diphenylmethane diisocyanate, triphenylmethane 4,4′,4″-triisocyanate or derivatives thereof having a urethane, isocyanurate, allophanate, biuret, uretdione and/or iminooxadiazinedione structure, and mixtures thereof. Preference is given to hexamethylene diisocyanate, isophorone diisocyanate and the isomeric bis(4,4′-isocyanatocyclohexyl)methanes, and to mixtures thereof.

The polyurethane (B) comprising in the aqueous coating compositions of the invention is a reaction product of

(a) one or more second precursor di- or polyisocyanates,

(b1) one or more hydrophilicizing compounds containing nonionic groups and/or ionic groups and/or groups which can be converted into ionic groups,

(b2) one or more compounds containing free-radically polymerizable groups,

(b3) if desired, one or more polyol compounds having an average molecular weight of from 50 to 500, preferably from 80 to 200, and a hydroxyl functionality of greater than or equal to 2 and less than or equal to 3,

(b4) if desired, one or more polyol compounds having an average molecular weight of from 500 to 13000 g/mol, preferably from 700 to 4000 g/mol with an average hydroxyl functionality of from 1.5 to 2.5, preferably from 1.8 to 2.2, with particular preference from 1.9 to 2.1,

(b5) if desired, one or more di- or polyamines.

Component (b1) contains ionic groups, which may be either cationic or anionic in nature, and/or nonionic hydrophilic groups. Cationically, anionically or nonionically dispersing compounds are those containing, for example, sulfonium, ammonium, phosphonium, carboxylate, sulfonate, phosphonate groups or the groups which can be converted by salt formation into the aforementioned groups (potentially ionic groups) or polyether groups, and can be incorporated into the macromolecules by isocyanate-reactive groups that are present. Preferred suitable isocyanate-reactive groups are hydroxyl groups and amine groups.

Suitable ionic or potentially ionic compounds (b1) are, for example, mono- and dihydroxycarboxylic acids, mono- and diaminocarboxylic acids, mono- and dihydroxysulfonic acids, mono- and diaminosulfonic acids and also mono- and dihydroxyphosphonic acids or mono- and diaminophosphonic acids and their salts such as dimethylolpropionic acid, dimethylolbutyric acid, hydroxypivalic acid, N-(2-aminoethyl)-β-alanine, 2-(2-aminoethylamino)ethanesulfonic acid, ethylenediamine-propyl- or butylsulfonic acid, 1,2- or 1,3-propylenediamine-β-ethylsulfonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts; the adduct of sodium bisulfite with but-2-ene-1,4-diol, polyethersulfonate, the propoxylated adduct of 2-butenediol and NaHSO₃, described for example in DE-A 2 446 440 (page 5-9, formula I-III), and also units which can be converted into cationic groups, such as N-methyldiethanolamine, as hydrophilic synthesis components. Preferred ionic or potential ionic compounds are those possessing carboxyl or carboxylate and/or sulfonate groups and/or ammonium groups. More preferred ionic compounds are those containing carboxyl and/or sulfonate groups as ionic or potentially ionic groups, such as the salts of N-(2-aminoethyl)-β-alanine, of 2-(2-aminoethylamino)ethanesulfonic acid or of the adduct of IPDI and acrylic acid (EP-A 0 916 647, Example 1) and also of dimethylolpropionic acid.

Suitable nonionically hydrophilicizing compounds are, for example, polyoxyalkylene ethers which contain at least one hydroxyl or amino group. These polyethers include a fraction of from 30% by weight to 100% by weight of units derived from ethylene oxide. They suitably include linear polyethers with a functionality of between 1 and 3, but also compounds of the general formula (I)

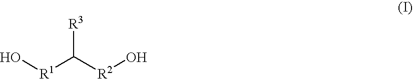

in which

R¹ and R² independently of one another each denote a divalent aliphatic, cycloaliphatic or aromatic radical having 1 to 18 carbon atoms which can be interrupted by oxygen and/or nitrogen atoms, and

R³ stands for an alkoxy-terminated polyethylene oxide radical.

Examples of nonionically hydrophilicizing compounds also include monohydric polyalkylene oxide polyether alcohols containing on average from 5 to 70, preferably from 7 to 55, ethylene oxide units per molecule, as are obtainable conventionally by alkoxylating suitable starter molecules (e.g. in Ullmanns Encyclopädie der technischen Chemie, 4th edition, Volume 19, Verlag Chemie, Weinheim pp. 31-38).

Examples of suitable starter molecules are saturated monoalcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxy-methyloxetane or tetrahydrofurfuryl alcohol, diethylene glycol monoalkyl ethers such as, for example, diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexy-lamine and also heterocyclic secondary amines such as morpholine, pyrrolidine, piperidine or 1H-pyrazole. Preferred starter molecules are saturated monoalcohols. Particular preference is given to using diethylene glycol monobutyl ether as a starter molecule.

Alkylene oxides suitable for the alkoxylation reaction are, in particular, ethylene oxide and propylene oxide, which can be used in any order or else in a mixture for the alkoxylation reaction.

The polyalkylene oxide polyether alcohols are either pure polyethylene oxide polyethers or mixed polyalkylene oxide polyethers at least 30 mol % preferably at least 40 mol % of whose alkylene oxide units are composed of ethylene oxide units. Preferred nonionic compounds are monofunctional mixed polyalkylene oxide polyethers containing at least 40 mol % of ethylene oxide and not more than 60 mol % of propylene oxide units.

Component (b1) is preferably a combination of nonionic and ionic hydrophilicizing agents. Particular preference is given to combinations of nonionic and anionic hydrophilicizing agents.

Component (b2) contains free-radically polymerizable double bonds, preferably hydroxy-functional acrylates or methacrylates. Examples are 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates, such as Tone® M100 (Union Carbide, USA), 2-hydroxypropyl (meth)acrylate, 4-hydroxybutyl (meth)acrylate, 3-hydroxy-2,2-dimethylpropyl (meth)acrylate, the mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipentaerythritol or the technical-grade mixtures thereof. Preference is given to the acrylated monoalcohols. Also suitable are alcohols obtainable from the reaction of acids containing double bonds with monomeric epoxide compounds optionally containing double bonds, such as, for example, the reaction products of (meth)acrylic acid with glycidyl (meth)acrylate or with the glycidyl ester of versatic acid.

Additionally, isocyanate-reactive oligomeric or polymeric unsaturated compounds containing acrylate and/or methacrylate groups can be used, alone or in combination with the aforementioned monomeric compounds. As component (b2) it is preferred to use hydroxyl-containg polyester acrylates having an OH content of from 30 to 300 mg KOH/g, preferably from 60 to 200, with particular preference from 70 to 120. For the preparation of the hydroxy-functional polyester acrylates it is possible to employ a total of 7 groups of monomer constituents:

1. (Cyclo)alkanediols such as dihydric alcohols containing (cyclo)aliphatically attached hydroxyl groups of the molecular weight range from 62 to 286, e.g. ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen, such as diethylene glycol, triethylene glycol, tetraethylene glycol, dipropylene glycol, tripropylene glycol, polyethylene, polypropylene or polybutylene glycols having a molecular weight of from 200 to 4000, preferably from 300 to 2000, with particular preference from 450 to 1200. Reaction products of the aforementioned diols with ε-caprolactone or other lactones may likewise be employed as diols.

2. Alcohols with a functionality of three or more, from the molecular weight range from 92 to 254, such as glycerol, trimethylolpropane, pentaerythritol, dipentaerythritol and sorbitol, or polyethers prepared starting from these alcohols, such as the reaction product of 1 mol of trimethylolpropane with 4 mol of ethylene oxide.

3. Monoalcohols such as ethanol, 1- and 2-propanol, 1- and 2-butanol, 1-hexanol, 2-ethylhexanol, cyclohexanol and benzyl alcohol.

4. Dicarboxylic acids from the molecular weight range from 104 to 600 and/or their anhydrides, such as phthalic acid, phthalic anhydride, isophthalic acid, tetrahydrophthalic acid, tetrahydrophthalic anhydride, hexahydrophthalic acid, hexahydrophthalic anhydride, cyclohexane dicarboxylic acid, maleic anhydride, fumaric acid, malonic acid, succinic acid, succinic anhydride, glutaric acid, adipic acid, pimelic acid, suberic acid, sebacic acid, dodecanedioic acid, hydrogenated dimer fatty acids.

5. Higher polyfunctional carboxylic acids and/or their anhydrides, such as trimellitic acid and trimellitic anhydride.

6. Monocarboxylic acids, such as benzoic acid, cyclohexanecarboxylic acid, 2-ethylhexanoic acid, caproic acid, caprylic acid, capric acid, lauric acid, natural and synthetic fatty acids.

7. Acrylic acid, methacrylic acid and/or dimeric acrylic acid.

Suitable hydroxyl-containing polyester acrylates comprise the reaction product of at least one constituent from group 1 or 2 with at least one constituent from group 4 or 5 and at least one constituent from group 7.

Where appropriate, groups with a dispersing action which are common knowledge from the prior art can also be incorporated into these polyester acrylates. For instance, as the alcohol component it is possible to make proportional use of polyethylene glycols and/or methoxy polyethylene glycols. Examples of compounds that may be mentioned include alcohol-derived polyethylene glycols, polypropylene glycols and the block copolymers thereof, and also the monomethyl ethers of these polyglycols. Particular suitability is possessed by polyethylene glycol 1500 monomethyl ether and/or polyethylene glycol 500 monomethyl ether.

Furthermore, it is possible, after the esterification, to react some carboxyl groups, especially those of the (meth)acrylic acid, with mono-, di- or polyepoxides. Preferred epoxides (glycidyl ethers) are, for example, those of monomeric, oligomeric or polymeric bisphenol A, bisphenol F, hexanediol and/or butanediol or their ethoxylated and/or propoxylated derivatives. This reaction may be used in particular to raise the OH number of the polyester (meth)acrylate, since one OH group is formed in each epoxide-acid reaction. The acid number of the resulting product lies between 0 and 20 mg KOH/g, preferably between 0 and 10 mg KOH/g and with particular preference between 0 and 5 mg KOH/g. The reaction is preferably catalysed by catalysts such as triphenylphosphine, thiodiglycol, ammonium and/or phosphonium halides and/or zirconium or tin compounds such as tin(II) ethylhexanoate.

The preparation of polyester acrylates is described in DE-A 4 040 290 (p. 3, line 25-p. 6, line 24), DE-A-3 316 592 (p. 5, line 14-p. 11, line 30) and P. K. T. Oldring (Ed.), Chemistry & Technology of UV & EB Formulations For Coatings, Inks & Paints, Vol. 2, 1991, SITA Technology, London, pp. 123-135.

Likewise preferred as component (b2) are the conventional hydroxyl-containing epoxy (meth)acrylates having OH contents of from 20 to 300 mg KOH/g, preferably from 100 to 280 mg KOH/g, with particular preference from 150 to 250 mg KOH/g, or hydroxyl-containing polyurethane (meth)acrylates having OH contents of from 20 to 300 mg KOH/g, preferably from 40 to 150 mg KOH/g, with particular preference from 50 to 100 mg KOH/g, and also their mixtures with one another and mixtures with hydroxyl-containing unsaturated polyesters and also mixtures with polyester (meth)acrylates or mixtures of hydroxyl-containing unsaturated polyesters with polyester (meth)acrylates. Such compounds are likewise described in P. K. T. Oldring (Ed.), Chemistry & Technology of UV & EB Formulations For Coatings, Inks & Paints, Vol. 2, 1991, SITA Technology, London pp. 37-56. Hydroxyl-containing epoxy (meth)acrylates are based in particular on reaction products of acrylic acid and/or methacrylic acid with epoxides (glycidyl compounds) of monomeric, oligomeric or polymeric bisphenol A, bisphenol F, hexanediol and/or butanediol or their ethoxylated and/or propoxylated derivatives.

Suitable low molecular weight polyols (b3) are short-chain, i.e. C₂ to C₂₀, aliphatic, araliphatic or cycloaliphatic diols or triols. Examples of diols are ethylene glycol, diethylene glycol, triethylene glycol, tetraethylene glycol, dipropylene glycol, tripropylene glycol, 1,2-propanediol, 1,3-propanediol, 1,4-butanediol, neopentyl glycol, 2-ethyl-2-butylpropanediol, trimethylpentanediol, positionally isomeric diethyloctanediols, 1,3-butylene glycol, cyclohexanediol, 1,4-cyclohexanedimethanol, 1,6-hexanediol, 1,2- and 1,4-cyclohexanediol, hydrogenated bisphenol A (2,2-bis(4-hydroxycyclohexyl)propane), 2,2-dimethyl-3-hydroxypropyl 2,2-dimethyl-3-hydroxypropionate. Preference is given to 1,4-butanediol, 1,4-cyclohexanedimethanol and 1,6-hexanediol. Examples of suitable triols are trimethylolethane, trimethylolpropane or glycerol; trimethylolpropane is preferred.

Suitable polyols of higher molecular weight (b4) are diols or polyols having a number-average molecular weight in the range from 500 to 13000 g/mol, preferably from 700 to 4000 g/mol. Preferred polymers are those having an average hydroxyl functionality of from 1.5 to 2.5, preferably from 1.8 to 2.2, with particular preference from 1.9 to 2.1. They include, for example, polyester alcohols based on aliphatic, cycloaliphatic and/or aromatic dicarboxylic, tricarboxylic and/or polycarboxylic acids with diols, triols and/or polyols, and also lactone-based polyester alcohols. Preferred polyester alcohols are, for example, reaction products of adipic acid with hexanediol, butanediol or neopentyl glycol or mixtures of the said diols having a molecular weight from 500 to 4000, with particular preference from 800 to 2500. Likewise suitable are polyetherols, which are obtainable by polymerizing cyclic ethers or by reacting alkylene oxides with a starter molecule. By way of example, mention may be made of the polyethylene and/or polypropylene glycols with an average molecular weight of from 500 to 13000, and also polytetrahydrofurans with an average molecular weight of from 500 to 8000, preferably from 800 to 3000. Likewise suitable are hydroxyl-terminated polycarbonates obtainable by reacting diols or else lactone-modified diols or else bisphenols, such as bisphenol A, with phosgene or carbonic diesters such as diphenyl carbonate or dimethyl carbonate. By way of example, mention may be made of the polymeric carbonates of 1,6-hexanediol having an average molecular weight of from 500 to 8000, and also the carbonates of reaction products of 1,6-hexanediol with ε-caprolactone in a molar ratio of from 1 to 0.1. Preference is given to aforementioned polycarbonate diols with an average molecular weight of from 800 to 3000 based on 1,6-hexanediol and/or carbonates of reaction products of 1,6-hexanediol with ε-caprolactone in a molar ratio of from 1 to 0.33. Hydroxyl-terminated polyamide alcohols and hydroxyl-terminated polyacrylatediols, e.g. Tegomer® BD 1000 (Tego GmbH, Essen, DE), can likewise be used.

Component (b5) is selected from the group of the diamines and/or polyamines, which are used for the purpose of increasing the molar mass and are preferably added towards the end of the polyaddition reaction. This reaction takes place preferably in the aqueous medium. In that case the diamines and/or polyamines must be more reactive than water towards the isocyanate groups of component (a). By way of example, mention may be made of ethylenediamine, 1,3-propylene-diamine, 1,6-hexamethylenediamine, isophoronediamine, 1,3-,1,4-phenylene-diamine, 4,4′-diphenylmethanediamine, amino-functional polyethylene oxides or polypropylene oxides, which are obtainable under the name Jeffamin®, D series (Huntsman Corp. Europe, Belgium), diethylenetriamine, triethylenetetramine and hydrazine. Preference is given to isophoronediamine, ethylenediamine and 1,6-hexamethylenediamine. Ethylenediamine is more preferred.

Proportionally it is also possible to add monoamines, such as butylamine, ethylamine and amines of the Jeffamin® M series (Huntsman Corp. Europe, Belgium), amino-functional polyethylene oxides and polypropylene oxides. The preparation of the polyurethane (B) may be conducted in one or more stages in homogeneous phase or, in the case of multistage reaction, partially in dispersed phase. Following polyaddition, carried out completely or partially, there is a dispersing, emulsifying or dissolving step. This is followed where appropriate by a further polyaddition or modification in dispersed phase.

For the preparation of the polyurethane (B) it is possible to use all of the techniques known from the prior art, such as emulsifier-shear force, acetone, prepolymer mixing, melt emulsification, ketimine and solids-spontaneous dispersion techniques, or derivatives thereof. A compilation of these methods can be found in Methoden der organischen Chemie (Houben-Weyl, Additional and Supplementary Volumes to the 4th edition, volume E20, H. Bartl and J. Falbe, Stuttgart, N.Y., Thieme 1987, pp. 1671-1682). Preference is given to the melt emulsification technique and to the acetone technique. The acetone technique is more preferred.

Normally, for the preparation of a polyurethane prepolymer, the reactor is charged in whole or in part with constituents (b1) to (b5) which contain no primary or secondary amino groups and with a polyisocyanate (a) and this initial charge is diluted where appropriate with a water-miscible but isocyanate-inert solvent, but preferably without solvent, and is heated to relatively high temperatures, preferably in the range from 50 to 120° C.

Examples of suitable solvents are acetone, butanone, tetrahydrofuran, dioxane, acetonitrile, dipropylene glycol dimethyl ether and 1-methyl-2-pyrrolidone, which can be added not only at the beginning of the preparation but also, where appropriate, in portions later on as well. Acetone and butanone are preferred. It is possible to conduct the reaction under atmospheric pressure or elevated pressure; for example, above the atmospheric-pressure boiling temperature of an optionally added solvent, such as acetone, for example.

It is additionally possible to include the catalysts known to accelerate the isocyanate addition reaction in the initial charge or to meter them in later, examples of these catalysts being triethylamine, 1,4-diazabicyclo[2.2.2]octane, tin dioctoate or dibutyltin dilaurate. Dibutyltin dilaurate is preferred.

Subsequently, any constituents (a) and/or (b1) to (b4) containing no primary or secondary amino groups that were not added at the beginning of the reaction are metered in. In the preparation of the polyurethane prepolymer, the molar ratio of isocyanate groups to isocyanate-reactive groups is from 0.90 to 3, preferably from 0.95 to 2, with particular preference from 1.05 to 1.5. The reaction of components (a) with (b) takes place partly or completely, but preferably completely, based on the total amount of isocyanate-reactive groups of the portion of (b) that contains no primary or secondary amino groups. The degree of reaction is normally monitored by following the NCO content of the reaction mixture. For this purpose it is possible to perform both spectroscopic measurements, e.g. infrared or near-infrared spectra, determinations of the refractive index, and chemical analyses, such as titrations, on samples taken. Polyurethane prepolymers containing free isocyanate groups are obtained, without solvent or in solution.

The preparation of the polyurethane prepolymers from (a) and (b) is followed or accompanied, if not already carried out in the starting molecules, by the partial or complete formation of salts of the anionically and/or cationically dispersing groups. In the case of anionic groups, this is done using bases such as ammonia, ammonium carbonate or hydrogen carbonate, trimethylamine, triethylamine, tributylamine, diisopropylethylamine, dimethylethanolamine, diethylethanolamine, triethanolamine, potassium hydroxide or sodium carbonate, preferably triethylamine, triethanolamine, dimethylethanolamine or diisopropylethylamine. The molar amount of the bases is between 50 and 100%, preferably between 60 and 90%, of the molar amount of the anionic groups. In the case of cationic groups use is made of dimethyl sulfate or succinic acid. Where only nonionically hydrophilicized compounds (b1) containing ether groups are used, there is no need for the neutralization step. Neutralization may also take place simultaneously with dispersion, with the dispersing water already containing the neutralizing agent.

Any remaining isocyanate groups are reacted with amine-type components (b5) and/or, if present, with amine-type components (b1). This chain extension can be carried out either in solvent before dispersion or in water after dispersion. Where amine-type components are present in (b1), chain extension preferably takes place prior to dispersion.

The diamines or polyamines (b5) and/or if present, the amine-type component (b1) can be added in dilution with organic solvents and/or with water to the reaction mixture. It is preferred to use from 70 to 95% by weight of solvent and/or water. Where two or more amine-type components (b1) and/or (b5) are present, the reaction may take place in succession, in any order, or simultaneously, by addition of a mixture.

To prepare the polyurethane dispersion (B), the polyurethane prepolymers are either introduced into the dispersing water, where appropriate under high shear, such as vigorous stirring, for example, or, conversely, the dispersing water is stirred into the prepolymers. This can be followed, if it has not already taken place in the homogeneous phase, by the raising of the molar mass by reaction of any isocyanate groups present with component (b5). The amount of polyamine (b5) employed depends on the unreacted isocyanate groups still present. It is preferred to react from 50 to 100%, with particular preference from 75 to 95%, of the molar amount of isocyanate groups with polyamines (b5).

The resultant polyurethane-polyurea prepolymers have an isocyanate content of from 0 to 2% by weight, preferably from 0 to 0.5% by weight.

Where appropriate, the organic solvent can be removed by distillation. The dispersions have a solids content of from 20 to 70% by weight, preferably from 30 to 65% by weight. The non-volatile fractions of these dispersions contain from 0 to 0.53 mmol/g, preferably from 0 to 0.4 mmol/g, with particular preference from 0 to 0.25 mmol/g, of chemical groups containing Zerevitinov-active hydrogen atoms.

Suitable blocked polyisocyanates (A) present in the sizing compositions for use in accordance with the invention are water-dispersible or water-soluble blocked polyisocyanates.

Suitable water-dispersible or water-soluble blocked polyisocyanates (A) are obtained by reacting

(A1) at least one first precursor polyisocyanate containing aliphatically, cycloaliphatically, araliphatically and/or aromatically attached isocyanate groups,

(A2) at least one ionic or potentially ionic and/or nonionic compound,

(A3) at least one blocking agent,

(A4) if desired, one or more (cyclo)aliphatic mono- or polyamines having from 1 to 4 amino groups, from the molecular weight range from 32 to 300,

(A5) if desired, one or more polyhydric alcohols having from 1 to 4 hydroxyl groups, from the molecular weight range from 50 to 250, and

(A6) if desired, one or more compounds containing isocyanate-reactive and unsaturated groups.

The polyisocyanates (A) may comprise, where appropriate, stabilizers (A7) and other auxiliaries and also, where appropriate, solvents (A8).

The water-dispersible or water-soluble blocked polyisocyanates (A) are synthesized from the following: from 20 to 80% by weight, preferably from 25 to 75% by weight, with particular preference from 30 to 70% by weight, of component (A1), from 1 to 40% by weight, preferably from 1 to 35% by weight, with particular preference from 5 to 30% by weight, of component (A2), from 15 to 60% by weight, preferably from 20 to 50% by weight, with particular preference from 25 to 45% by weight, of component (A3), from 0 to 15% by weight, preferably from 0 to 10% by weight, with particular preference from 0 to 5% by weight, of component (A4), from 0 to 15% by weight, preferably from 0 to 10% by weight, with particular preference from 0 to 5% by weight, of component (A5), from 0 to 40% by weight, preferably 0% by weight, of component (A6), and also from 0 to 15% by weight, preferably from 0 to 10% by weight, with particular preference from 0 to 5% by weight, of component (A7) and, where appropriate, from 0 to 20% by weight, preferably from 0 to 15% by weight, with particular preference from 0 to 10% by weight, of component (A8), the sum of the components adding up to 100% by weight.

The water-dispersible or water-soluble blocked polyisocyanates (A) can be used in the coating compositions of the invention in the form of an aqueous solution or dispersion. The solution or dispersion of polyisocyanates has a solids content of between 10 to 70% by weight, preferably from 20 to 60% by weight and with particular preference from 25 to 50% by weight and the proportion of (A8) in the overall composition is preferably less than 15% by weight and with particular preference less than 10% by weight and with very particular preference less than 5% by weight.

The first precursor polyisocyanates (A1) used to prepare the blocked polyisocyanates (A) have an (average) NCO functionality of from 2.0 to 5.0, preferably from 2.3 to 4.5, an isocyanate group content of from 5.0 to 27.0% by weight, preferably from 14.0 to 24.0% by weight, and a monomeric diisocyanate content of less than 1% by weight, preferably less than 0.5% by weight. The isocyanate groups of the polyisocyanates (A1) are at least 50%, preferably at least 60% and with particular preference at least 70% in blocked form.

Suitable first precursor polyisocyanates (A1) for preparing the blocked polyisocyanates (A) are the polyisocyanates synthesized from at least two diisocyanates and prepared by modifying simple aliphatic, cycloaliphatic, araliphatic and/or aromatic diisocyanates, and having a uretdione, isocyanurate, allophanate, biuret, iminooxadiazinedione and/or oxadiazinetrione structure, as described by way of example in, for example, J. Prakt. Chem. 336 (1994) page 185-200.

Suitable compounds for component (A2) are ionic or potentially ionic and/or nonionic compounds as already described under component (b1).

Component (A2) is preferably a combination of nonionic and ionic hydrophilicizing agents. Particular preference is given to combinations of nonionic and anionic hydrophilicizing agents.

Examples that may be mentioned of blocking agents (A3) include the following: alcohols, lactams, oximes, malonates, alkyl acetoacetates, triazoles, phenols, imidazoles, pyrazoles, and amines, such as butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-tert-butylbenzylamine or any desired mixtures of these blocking agents. Preference is given to using butanone oxime, 3,5-dimethylpyrazole, ε-caprolactam, N-tert-butylbenzylamine as blocking agent (A3). More preferred blocking agents (A3) are butanone oxime and ε-caprolactam.

Suitable components (A4) include mono-, di-, tri-, and/or tetra-amino-functional substances of the molecular weight range up to 300, such as ethylenediamine, 1,2- and 1,3-diaminopropane, 1,3-, 1,4- and 1,6-diaminohexane, 1,3-diamino-2,2-dimethylpropane, 1-amino-3,3,5-trimethyl-5-aminoethylcyclohexane (IPDA), 4,4′-diaminodicyclohexylmethane, 2,4- and 2,6-diamino-1-methylcyclohexane, 4,4′-diamino-3,3′-dimethyldicyclohexylmethane, 1,4-bis(2-aminoprop-2-yl)cyclo-hexane or mixtures of these compounds.

Component (A5) comprises mono-, di-, tri- and/or tetra-hydroxy-functional substances of molecular weight up to 250, such as ethylene glycol, propylene glycol, 1,4-butanediol, 1,6-hexanediols, glycerol, trimethylolethane, trimethylol-propane, the isomeric hexanetriols, pentaerythritol or mixtures of these compounds.

As component (A6), hydroxy-functional and (meth)acryloyl-functional compounds are reacted with the isocyanates. Such compounds are described by way of example as constituents of component (b2) above. Preference is given to compounds having an average hydroxy functionality of from 0.2 to 2, with particular preference from 0.7 to 1.3. Particular preference is given to 2-hydroxy-ethyl (meth)acrylate, poly(ε-caprolactone) monoacrylates, such as Tone M100® (Union Carbide, USA), 2-hydroxypropyl acrylate, 4-hydroxybutyl acrylate, trimethylolpropane diacrylate, glycerol diacrylate, pentaerythritol triacrylate or dipentaerythritol pentaacrylate.

The blocked polyisocyanates (A) may where appropriate comprise a stabilizer or stabilizer mixture (A7). Examples of suitable compounds (A7) are antioxidants such as 2,6-di-tert-butyl-4-methylphenol, UV absorbers of the 2-hydroxyphenyl-benzotriazole type or light stabilizers of the HALS compound type or other commercially customary stabilizers, as described, for example, in “Lichtschutzmittel für Lacke” (A. Valet, Vincentz Verlag, Hannover, 1996), and “Stabilization of Polymeric Materials” (H. Zweifel, Springer Verlag, Berlin, 1997, Appendix 3, pp. 181-213).

Preference is given to stabilizer mixtures containing compounds having a 2,2,6,6-tetramethylpiperidinyl radical (HALS). The piperidinyl nitrogen of the HALS ring is unsubstituted and has no hydrazide structures at all. Particular preference is given to a compound of the formula (II),

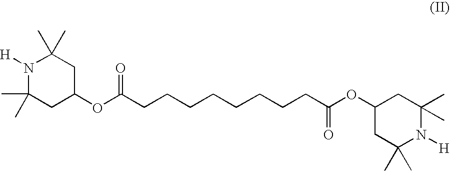

which is sold, for example, under the name Tinuvin® 770 DF by the company Ciba Spezialitäten (Lampertheim, DE).

Ideally, the abovementioned compounds are combined with substances possessing hydrazide structures, such as acid hydrazides and acid dihydrazides, for example, such as acetic hydrazide adipic hydrazide, adipic dihydrazide or else hydrazine adducts of hydrazine and cyclic carbonates, as specified, for example, in EP-A 654 490 (p. 3, line 48 to p. 4 line 3). It is preferred to use adipic dihydrazide and an adduct of 2 mol of propylene carbonate and 1 mol of hydrazine of the general formula (III),

—CO—NH—NH— (III).

Particular preference is given to the adduct of 2 mol of propylene carbonate and 1 mol of hydrazine, of the general formula (IV):

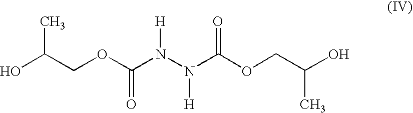

Suitable organic solvents (A8) include the paint solvents customary per se, such as ethyl acetate, butyl acetate, 1-methoxyprop-2-yl acetate, 3-methoxy-n-butyl acetate, acetone, 2-butanone, 4-methyl-2-pentanone, cyclohexanone, toluene, xylene, chlorobenzene or white spirit. Mixtures containing, in particular, aromatics with relatively high degrees of substitution, as sold, for example, under the names Solvent Naphtha, Solvesso® (Exxon Chemicals, Houston, USA), Cypar® (Shell Chemicals, Eschborn, DE), Cyclo Sol® (Shell Chemicals, Eschborn, DE), Tolu Sol® (Shell Chemicals, Eschborn, DE), Shellsol® (Shell Chemicals, Eschborn, DE) are likewise suitable. Examples of further solvents include carbonates, such as dimethyl carbonate, diethyl carbonate, 1,2-ethylene carbonate and 1,2-propylene carbonate, lactones, such as β-propiolactone, γ-butyrolactone, ε-caprolactone, ε-methylcaprolactone, propylene glycol diacetate, diethylene glycol dimethyl ether, dipropylene glycol dimethyl ether, diethylene glycol ethyl and butyl ether acetate, N-methylpyrrolidone and N-methylcaprolactam or any desired mixtures of such solvents. Preferred solvents are acetone, 2-butanone, 1-methoxyprop-2-yl acetate, xylene, toluene, mixtures containing, in particular, aromatics with relatively high degrees of substitution, as sold, for example, under the names Solvent Naphtha, Solvesso® (Exxon Chemicals, Houston, USA), Cypar® (Shell Chemicals, Eschborn, DE), Cyclo Sol® (Shell Chemicals, Eschborn, DE), Tolu Sol® (Shell Chemicals, Eschborn, DE), Shellsol® (Shell Chemicals, Eschborn, DE), and N-methylpyrrolidone. Particular preference is given to acetone, 2-butanone and N-methylpyrrolidone.

The blocked polyisocyanates (A) may be prepared by known methods of the prior art (e.g. in DE-A 2 456 469, column 7-8, Example 1-5 and DE-A 2 853 937 pp. 21-26, Example 1-9).

The water-dispersible or water-soluble blocked polyisocyanates (A) may be reacted, for example, by reacting the components (A1), (A2), (A3) and, where appropriate, (A4) to (A7) in any desired order, where appropriate with the assistance of an organic solvent (A8).

It is preferred to react first (A1) with, where appropriate, a portion, preferably the nonionic portion, of component (A2) and also, where appropriate (A4) and (A5). This is followed by blocking with component (A3) and, subsequently, by reaction with the portion of component (A2) containing ionic groups. Where appropriate, organic solvents (A8) may be added to the reaction mixture. In a further step, where appropriate, component (A7) is added.

The preparation of the aqueous solution or dispersion of the blocked polyisocyanates (A) takes place subsequently by converting the water-dispersible blocked polyisocyanates into an aqueous dispersion or solution by adding water. The organic solvent (A8) used where appropriate may be removed by distillation following the dispersion. It is preferred not to use solvent (A8).

Aforementioned water-dispersible or water-soluble blocked polyisocyanates may also contain unsaturated groups capable of free-radical polymerization. For this purpose the polyisocyanates, before being dispersed, emulsified or dissolved in water, may first be partly blocked and then reacted with isocyanate-reactive compounds (A6) containing unsaturated groups, or the polyisocyanates are reacted first with isocyanate-reactive compounds (A6) containing unsaturated groups and then with blocking agents (A3).

For the preparation of the aqueous solution or dispersion of the blocked polyisocyanates (A) the amounts of water used are generally such that the resulting dispersions have a solids content of from 10 to 70% by weight, preferably from 20 to 60% by weight and with particular preference from 25 to 50% by weight.

As initiators (C) for a free-radical polymerization it is possible to employ radiation-activable and/or heat-activable initiators. Photoinitiators which are activated by UV or visible light are preferred in this context. Photoinitiators are commercially trafficked compounds which are known per se, a distinction being made between unimolecular (type I) and bimolecular (type II) initiators. Suitable (type I) systems are like aromatic ketone compounds, e.g. benzophenones in combination with tertiary amines, alkylbenzophenones, 4,4′-bis(dimethylamino)benzophenone (Michler's ketone), anthrone and halogenated benzophenones or mixtures of the said types. Further suitability is possessed by (type II) initiators such as benzoin and its derivatives, benzil ketals, acylphosphine oxides such as 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. Preference is given to photoinitiators which are easy to incorporate into aqueous coating compositions. Examples of such products are Irgacure® 500, Irgacure® 819 DW (Ciba, Lampertheim, DE), Esacure® KIP (Lamberti, Aldizzate, Italy). It is also possible to use mixtures of these compounds.

Where curing is initiated thermally, peroxy compounds are suitable, such as diacyl peroxides, e.g. benzoyl peroxide, alkyl hydroperoxide such as diisopropylbenzene monohydroperoxide, alkyl peresters such as tert-butyl perbenzoate, dialkyl peroxides such as di-tert-butyl peroxide, peroxydicarbonates such as dicetyl peroxide dicarbonate, inorganic peroxides such as ammonium peroxodisulfate, potassium peroxodisulfate or else azo compounds such as 2,2′-azobis[N-(2-propenyl)-2-methylpropionamides], 1-[(cyano-1-methylethyl)azo]formamides, 2,2′-azobis(N-butyl-2-methylpropionamides), 2,2′-azobis(N-cyclohexyl-2-methyl-propionamides), 2,2′-azobis{2-methyl-N-[2-(1-hydroxybutyl)]propionamides}, 2,2′-azobis{2-methyl-N-[2-(1-hydroxybutyl)]propionamides, 2,2′-azobis}2-methyl-N-[1,1-bis(hydroxymethyl)-2-hydroxyethyl]propionamides, and also benzpinacol. Preferred compounds are those which are soluble in water or in the form of aqueous emulsions. These free-radical initiators may be combined, familiarly, with accelerators.

To prepare the aqueous sizing composition the constituents (I), (II) and (III) are mixed in succession in any order or simultaneously with one another. The aqueous coating compositions do not possess a pot life and are stable on storage for months or longer.

For the process of the invention the aqueous sizing composition is used alone or, where appropriate, with further binders such as, for example, polyurethane dispersions, polyacrylate dispersions, polyurethane-polyacrylate hybrid dispersions, polyvinyl ether or polyvinyl ester dispersions, polystyrene or polyacrylontrile dispersions, also in combination with further blocked polyisocyanates and amino crosslinker resins such as, for example, melamine resins.

The sizing composition may comprise the customary auxiliaries and additives, such as defoamers, thickeners, levelling agents, dispersing auxiliaries, catalysts, anti-skinning agents, anti-settling agents, antioxidants, plasticizers, reactive diluents, emulsifiers, biocides, coupling agents, based for example on the known low and/or high molecular weight silanes, lubricants, wetting agents, antistats.

Coupling agents used are, for example, the known silane coupling agents, examples being 3-aminopropyltrimethoxy- or triethoxysilane, N-(2-aminoethyl)-3-aminopropyltrimethoxysilane, 3-glycidylpropyltrimethoxysilane, vinyltrimethoxysilane, vinyltriethoxysilane or 3-methacryloyloxypropyltriethoxysilane. The concentration of the silane coupling agents in the sizing agents of the invention is preferably from 0.05 to 2% by weight, more preferably from 0.15 to 0.85% by weight based on the overall size.

The sizes comprise one or more nonionic and/or ionic lubricants, which may be composed, for example, of the following groups of substances: polyalkylene glycol ethers of fatty alcohols or fatty amines, polyalkylene glycol ethers and glyceryl esters of fatty acids having 12 to 18 carbon atoms, polyalkylene glycols, higher fatty acid amides having 12 to 18 carbon atoms of polyalkylene glycols and/or alkylenamines, quaternary nitrogen compounds, for example ethoxylated imidazolinium salts, mineral oils and waxes. The lubricant or lubricants are employed preferably in the overall concentration of between 0.05 and 1.5% by weight based on the overall size.

The sizes may comprise one or more antistats, such as lithium chloride, ammonium chloride, Cr(III) salts, organotitanium compounds, arylalkyl sulfates or sulfonates, aryl polyglycol ether sulfonates or quaternary nitrogen compounds. The antistats are employed preferably in concentrations of from 0.01 to 0.8% by weight.

Furthermore, where appropriate, the sizes additionally comprise further auxiliaries and additives known from the prior art, as described, for example, in K. L. Loewenstein, “The Manufacturing Technology of Continuous Glass Fibres”, Elsevier Scientific Publishing Corp., Amsterdam, London, New York, 1983.

The sizes can be prepared by the methods which are known per se. Preferably, about half of the total amount of water needed is charged to a suitable mixing vessel and, with stirring, the binder, the curing agent, and subsequently the lubricant 4) and, where appropriate, other, customary auxiliaries are added. Thereafter the pH is adjusted to 5-7 and then hydrolysate of an adhesion promoter, e.g. of a trialkoxysilane, prepared in accordance with the instructions of the manufacturer (e.g. UCC, New York) is added. After a further stirring time of 15 minutes the size is ready for use; where appropriate, the pH is readjusted to 5-7.

The sizes can be applied to the glass fibers by any desired methods, for example with the aid of suitable equipment, such as spray applicators or roll applicators, for example.

Suitable glass fibers are not only the known types of glass used for fiberglass manufacture, such as E, A, C, and S glass, but also the other conventional products from the glass fiber manufacturers. Preference is given to E glass fibers, which are used for the production of continuous glass fibers on the basis of their freedom from alkali, high tensile strength and high modulus of elasticity for the reinforcement of plastics.

The process for the preparation, the process of sizing, and the subsequent processing of the glass fibers is known and is described, for example, in K. L. Loewenstein, “The Manufacturing Technology of Continuous Glass Fibres”, Elsevier Scientific Publishing Corp., Amsterdam, London, New York, 1983.

The sizes are normally applied to the glass filaments, drawn at high speed from spinnerets, immediately after the filaments have solidified; that is, even before they are wound up. An alternative possibility is to size the fibers downstream of the spinning operation, in a dipping bath. The sized glass fibers can be processed either wet or dry to form, for example, chopped glass. The drying of the end product or intermediate takes place by exposure to high-energy radiation, preferably ultraviolet light, and/or by heating at temperatures between 50 to 200° C., preferably 70 to 150° C. Drying in this context means not solely the removal of other volatile constituents but also, for example, the solidification of the constituents of size. Only after drying is complete has the size undergone transformation into the finished coating material. The fraction of the size, based on the sized glass fibers, is preferably from 0.1 to 5.0% by weight more preferably from 0.1 to 3.0% by weight and with very particular preference from 0.3 to 1.5% by weight.

The sized glass fibers are preferably dried in several stages: first of all, heat, convection, thermal radiation and/or dehumidified air is used to remove water and any solvent present from the size. This is followed by curing by UV irradiation. Here, the customary, prior art radiation sources are employed. Preference is given to high- or medium-pressure mercury lamps, which where appropriate may have been doped with elements such as gallium or iron. It may also be appropriate to combine two or more lamps in series, alongside one another or in any desired three-dimensional arrangements. Furthermore, it may be appropriate to carry out UV irradiation at elevated temperatures, at 30 to 200° C.

The sized glass fibers may then be incorporated into matrix polymers.

As matrix polymers it is possible to use a large number of thermoplastics or thermosetting polymers. Examples of suitable thermoplastic polymers are the following: polyolefins such as polyethylene or polypropylene, polyvinyl chloride, addition polymers such as styrene/acrylonitrile copolymers, ABS, polymethacrylate or polyoxymethylene, aromatic and/or aliphatic polyamides such as polyamide 6 or polyamide 6,6, polycondensates such as polycarbonate, polyethylene terephthalate, liquid-crystalline polyaryl esters, polyarylene oxide, polysulfone, polyarylene sulfide, polyaryl sulfone, polyether sulfone, polyaryl ethers or polyether ketone or polyadducts such as polyurethane. Examples that may be mentioned of thermosetting polymers include the following: epoxy resins, unsaturated polyester resins, phenolic resins amine resins, polyurethane resins, polyisocyanurates, epoxide/isocyanurate combination resins, furan resins, cyanurate resins and bismaleimide resins.

Incorporation into the polymer matrix may take place by the methods known to the person skilled in the art which are common knowledge (such as extruding for example). Here, temperatures of between 150 and 300° C. are commonly reached, leading to a thermal aftercure of the size with liberation of the polyisocyanate groups by deblocking and, where appropriate, crosslinking thereof with the polymer matrix.

The invention is further illustrated but is not intended to be limited by the following examples in which all parts and percentages are by weight unless otherwise specified.

### EXAMPLES

UV PU Dispersions

### Example 1

Preparation of a polyester acrylate 1a) in analogy to DE-C 197 15 382 (p. 5, lines 21-27), OH number: 160 mg KOH/g, acid number: 1 mg KOH/g, viscosity: 0.5 Pa s at 23° C.

Preparation of a Polyurethane Dispersion

A reaction vessel with stirrer, internal thermometer and gas inlet (stream of air 1 l/h), is charged with 298.0 g of the polyester acrylate 1a) and 27.0 g of the polyether LB 25 (Bayer AG, DE, monofunctional polyether based on ethylene oxide/propylene oxide with an average molar weight of 2250 (OHN=25)) and this initial charge is melted. Following the addition of 168.6 g of isophorone diisocyanate (Desmodur I®, Bayer AG, DE) and 170.0 g of acetone, the reaction mixture is heated to reflux temperature. The reaction mixture is stirred at this temperature until it contains an NCO content of 3.6-3.8% by weight. When the NCO content has been reached, the prepolymer is dissolved in 350.0 g of acetone and adjusted to 40° C.

Subsequently a solution of 9.9 g of ethylenediamine, 47.5 g of 45% strength AAS (2-(2-aminoethylamino)ethanesulfonic acid, in water, Bayer AG, Leverkusen, DE) solution and 67.6 g of water is added over 2 minutes and the ingredients stirred together for 5 minutes. Then 692.8 g of water are added over the course of 10 minutes. The dispersion formed is stirred further at 40° C. until the presence of NCO in the dispersion can no longer be detected by IR spectroscopy.

The product is distilled under reduced pressure at temperatures below 50° C. until a solids of 39% has been reached. The dispersion has a pH of 7.0 and an average particle size of 86 nm (laser correlation spectroscopy measurement: Zetasizer 1000, Malvern Instruments, Malvern, UK).

### Example 2

Preparation of a Polyurethane Dispersion

A reaction vessel with stirrer, internal thermometer and gas inlet (stream of air 1 l/h), is charged with 298.0 g of the polyester acrylate 1a) and 27.0 g of the polyether LB 25 (Bayer AG, DE, monofunctional polyether based on ethylene oxide/propylene oxide with an average molar weight of 2250 (OHN=25)) and this initial charge is melted. Following the addition of 168.6 g of isophorone diisocyanate (Desmodur I®, Bayer AG, DE) and 170.0 g of acetone, the reaction mixture is heated to reflux temperature. The reaction mixture is stirred at this temperature until it contains an NCO content of 4.2-4.4% by weight. When the NCO content has been reached, the prepolymer is dissolved in 350.0 g of acetone and adjusted to 40° C.

Subsequently a solution of 11.4 g of ethylenediamine, 36.9 g of 45% strength AAS (2-(2-aminoethylamino)ethanesulfonic acid, in water, Bayer AG, Leverkusen, DE) solution and 63.7 g of water is added over 2 minutes and the ingredients stirred together for 5 minutes. Then 698.5 g of water are added over the course of 10 minutes. The dispersion formed is stirred further at 40° C. until the presence of NCO in the dispersion can no longer be detected by IR spectroscopy.

The product is distilled under reduced pressure at temperatures below 50° C. until a solids of 39% has been reached. The dispersion has a pH of 6.6 and an average particle size of 113 nm (laser correlation spectroscopy measurement: Zetasizer 1000, Malvern Instruments, Malvern, UK).

### Example 3

Preparation of a Polyurethane Dispersion

A reaction vessel with stirrer, internal thermometer and gas inlet (stream of air 1 l/h) is charged with 298.0 g of the polyester acrylate 1a) and 27.0 g of the polyether LB 25 (Bayer AG, DE, monofunctional polyether based on ethylene oxide/propylene oxide with an average molar weight of 2250 (OHN=25)) and this initial charge is melted. Following the addition of 168.6 g of isophorone diisocyanate (Desmodur I®, Bayer AG, DE) and 170.0 g of acetone, the reaction mixture is heated to reflux temperature. The reaction mixture is stirred at this temperature until it contains an NCO content of 4.2-4.4% by weight. When the NCO content has been reached, the prepolymer is dissolved in 350.0 g of acetone and adjusted to 40° C.

Subsequently a solution of 12.1 g of ethylenediamine, 31.7 g of 45% strength AAS (2-(2-aminoethylamino)ethanesulfonic acid, in water, Bayer AG, Leverkusen, DE) solution and 61.7 g of water is added over 2 minutes and the ingredients stirred together for 5 minutes. Then 700.9 g of water are added over the course of 10 minutes. The dispersion formed is stirred further at 40° C. until the presence of NCO in the dispersion can no longer be detected by IR spectroscopy.

The product is distilled under reduced pressure at temperatures below 50° C. until a solids of 39% has been reached. The dispersion has a pH of 6.8 and an average particle size of 83 nm (laser correlation spectroscopy measurement: Zetasizer 1000, Malvern Instruments, Malvern, UK).

### Example 4

Preparation of a Polyurethane Dispersion

A reaction vessel with stirrer, internal thermometer and gas inlet (stream of air 1 l/h), is charged with 139.0 g of the polyester PE 170 HN (ester based on adipic acid, 1,6-hexanediol, neopentyl glycol, MW=1700, Bayer AG, Leverkusen, DE), 238.5 g of the polyester acrylate 1a) and 27.0 g of the polyether LB 25 (Bayer AG, Leverkusen DE, monofunctional polyether based on ethylene oxide/propylene oxide with an average molar weight of 2250 (OHN=25)) and this initial charge is melted. Following the addition of 168.6 g of isophorone diisocyanate (Desmodur I®, Bayer AG, Lev., DE) and 170.0 g of acetone, the reaction mixture is heated to reflux temperature. The reaction mixture is stirred at this temperature until it contains an NCO content of 3.6-3.8% by weight. When the NCO content has been reached, the prepolymer is dissolved in 350.0 g of acetone and adjusted to 40° C.

Subsequently a solution of 11.4 g of ethylenediamine, 36.9 g of 45% strength AAS (2-(2-aminoethylamino)ethanesulfonic acid, in water, Bayer AG, Leverkusen, DE) solution and 63.7 g of water is added over 2 minutes and the ingredients stirred together for 5 minutes. Then 817.7 g of water are added over the course of 10 minutes. The dispersion formed is stirred further at. 40° C. until the presence of NCO in the dispersion can no longer be detected by IR spectroscopy.

The product is distilled under reduced pressure at temperatures below 50° C. until a solids of 40% has been reached. The dispersion has a pH of 6.8 and an average particle size of 83 nm (laser correlation spectroscopy measurement: Zetasizer 1000, Malvern Instruments, Malvern, UK).

### Example 5

Preparation of a Polyurethane Dispersion

A reaction vessel with stirrer, internal thermometer and gas inlet (stream of air 1 l/h) is charged with 278.0 g of the polyester PE 170 HN (ester based on adipic acid, 1,6-hexanediol, neopentyl glycol, MW=1700, Bayer AG, Leverkusen, DE), 179.0 g of the polyester acrylate 1a) and 27.0 g of the polyether LB 25 (Bayer AG, Lev., DE, monofunctional polyether based on ethylene oxide/propylene oxide with an average molar weight of 2250 (OHN=25)) and 170.0 g of acetone, the reaction mixture is heated to reflux temperature. The reaction mixture is stirred at this temperature until it contains an NCO content of 3.3-3.5% by weight. When the NCO content has been reached, the prepolymer is dissolved in 350.0 g of acetone and adjusted to 40° C.

Subsequently a solution of 11.4 g of ethylenediamine, 36.9 g of 45% strength AAS (2-(2-aminoethylamino)ethanesulfonic acid, in water, Bayer AG, Leverkusen, DE) solution and 63.7 g of water is added over 2 minutes and the ingredients stirred together for 5 minutes. Then 936.9 g of water are added over the course of 10 minutes. The dispersion formed is stirred further at 40° C. until the presence of NCO in the dispersion can no longer be detected by IR spectroscopy.

The product is distilled under reduced pressure at temperatures below 50° C. until a solids of 40% has been reached. The dispersion has a pH of 6.7 and an average particle size of 176 nm (laser correlation spectroscopy measurement: Zetasizer 1000, Malvern Instruments, Malvern, UK).

### Example 6

Preparation of a Polyurethane Dispersion

A reaction vessel with stirrer, internal thermometer and gas inlet (stream of air 1 l/h) is charged with 418.0 g of the polyester PE 170 HN (ester based on adipic acid, 1,6-hexanediol, neopentyl glycol, MW=1700, Bayer AG, Leverkusen, DE), 119.0 g of the polyester acrylate 1a) and 27.0 g of the polyether LB 25 (Bayer AG, Lev., DE, monofunctional polyether based on ethylene oxide/propylene oxide with an average molar weight of 2250 (OHN=25)) and this initial charge is melted. Following the addition of 168.6 g of isophorone diisocyanate (Desmodur I®, Bayer AG, Lev., DE) and 170.0 g of acetone, the reaction mixture is heated to reflux temperature. The reaction mixture is stirred at this temperature until it contains an NCO content of 3.0-3.2% by weight. When the NCO content has been reached, the prepolymer is dissolved in 350.0 g of acetone and adjusted to 40° C.

Subsequently a solution of 11.4 g of ethylenediamine, 36.9 g of 45% strength AAS (2-(2-aminoethylamino)ethanesulfonic acid, in water, Bayer AG, Leverkusen, DE) solution and 63.7 g of water is added over 2 minutes and the ingredients stirred together for 5 minutes. Then 1057.2 g of water are added over the course of 10 minutes. The dispersion formed is stirred further at 40° C. until the presence of NCO in the dispersion can no longer be detected by IR spectroscopy.

The product is distilled under reduced pressure at temperatures below 50° C. until a solids of 40% has been reached. The dispersion has a pH of 6.7 and an average particle size of 192 nm (laser correlation spectroscopy measurement: Zetasizer 1000, Malvern Instruments, Malvern, UK).

Water-dispersible blocked polyisocyanates (A)

### Example 7

108.4 g of a polyisocyanate containing biuret groups and based on 1,6-diisocyanatohexane (HDI), having an NCO content of 23.0%, are introduced at 40° C. Over the course of 10 minutes, 91.1 g of polyether LB 25 (Bayer AG, Lev., DE, monofunctional polyether based on ethylene oxide/propylene oxide, having an average molar weight of 2250 (OHN=25) and 1.2 g of the abovementioned hydrazine adduct of 1 mol of hydrazine hydrate and 2 mol of propylene carbonate of molecular weight 236 of the formula (III) are metered in with stirring. The reaction mixture is subsequently heated to 90° C. and is stirred at this temperature until the theoretical NCO value has been reached. After cooling to 65° C., 88.3 g of N-tert-butyl benzylamine are added dropwise with stirring over the course of 30 minutes at a rate such that the temperature of the mixture does not exceed 70° C. Then 1.5 g of Tinuvin® 770 DF (Ciba Spezialitäten GmbH, Lampertheim, DE) are added, stirring is continued for 10 minutes and the reaction mixture is cooled to 60° C. Dispersing is carried out by adding 713.0 g of water (20° C.) at 60° C. over the course of 30 minutes. The subsequent stirring time at 40° C. is 1 hour. A storage-stable aqueous dispersion of the blocked polyisocyanate is obtained with a solids content of 27.3%.

### Example 8

147.4 g of a polyisocyanate containing biuret groups and based on 1,6-diisocyanatohexane (HDI), having an NCO content of 23.0%, are introduced at 40° C. Over the course of 10 minutes, 121.0 g of polyether LB 25 (Bayer AG, Lev., DE, monofunctional polyether based on ethylene oxide/propylene oxide, having an average molar weight of 2250 (OHN=25) are metered in with stirring. The reaction mixture is subsequently heated to 90° C. and is stirred at this temperature until the theoretical NCO value has been reached. After cooling to 65° C., 62.8 g of butanone oxime are added dropwise with stirring over the course of 30 minutes at a rate such that the temperature of the mixture does not exceed 80° C. Dispersing is carried out by adding 726.0 g of water (T=20° C.) at 60° C. over the course of minutes. The subsequent stirring time at 40° C. is 1 hour. A storage-stable aqueous dispersion of the blocked polyisocyanate is obtained with a solids content of 30.0%.

### Example 9

13.5 g of polyether LB. 25 (Bayer AG, Lev., DE, monofunctional polyether based on ethylene oxide/propylene oxide, having an average molecular weight of 2250 (OHN=25)) and 122.6 g of N-tert-butylbenzylamine are introduced as an initial charge and heated with stirring to 90° C. Then 193.0 [lacuna] of a polyisocyanate containing isocyanurate groups and based on 1,6-diisocyanatohexane (HDI), having an NCO content of 21.8%, are added over the course of 30 minutes at a rate such that the temperature of the reaction mixture does not exceed 70° C. Following the addition of 11.1 g of the abovementioned hydrazine adduct of 1 mol of hydrazine hydrate and 2 mol of propylene carbonate, of molecular weight 236, the mixture is stirred at 70° C. until the theoretical NCO value has been reached. Then 3.5 g of Tinuvin® 770 DF (Ciba Spezialitäten GmbH, Lampertheim, DE) are added at 70° C. over 5 minutes and the reaction mixture is stirred for 5 minutes more. 24.6 g of the hydrophilicizing agent KV 1386 (BASF AG, Ludwigshafen, DE) in solution in 73.7 g of water are metered in over the course of 2 minutes and the reaction mixture is stirred for 15 minutes more. Dispersing by adding 736.4 g of water (T=60° C.) in 10 min. The subsequent stirring time is 2 hours. A storage-stable dispersion is obtained having a solids of 27.6%.

### Example 10

963.0 g of a biuret-group-containing polyisocyanate based on 1,6-diisocyanatohexane (HDI), having an NCO content of 23.0%, are stirred with 39.2 g of polyether LB 25 (Bayer AG, Lev., DE, monofunctional polyether based on ethylene oxide/propylene oxide, having an average molar weight of 2250 (OHN=25)) and 7.8 g of the abovementioned hydrazine adduct of 1 mol of hydrazine hydrate and 2 mol of propylene carbonate, of molecular weight 236, at 100° C. for 30 minutes. Subsequently 493.0 g of ε-caprolactam are added over the course of 20 minutes at a rate such that the temperature of the reaction mixture does not exceed 110° C. The mixture is stirred at 110° C. until the theoretical NCO value has been reached and then is cooled to 90° C. Following the addition of 7.9 g of Tinuvin® 770 DF (Ciba Spezialitäten GmbH, Lampertheim, DE) and a subsequent stirring time of 5 minutes a mixture of 152.5 g of the hydrophilicizing agent KV 1386 (BASF AG, Ludwigshafen, DE) and 235.0 g of water is metered in over the course of 2 minutes, followed by stirring for a further 7 minutes at neutral temperature. Dispersing takes place thereafter, by addition of 3341.4 g of water. After a subsequent stirring time of 4 hours a storage-stable aqueous dispersion is obtained having a solids content of 29.9%.

### Example 11

192.6 g of a biuret-group-containing polyisocyanate based on 1,6-diisocyanatohexane (HDI), having an NCO content of 23.0%, are stirred with 7.8 g of polyether LB 25 (Bayer AG, Leverkusen, DE, monofunctional polyether based on ethylene oxide/propylene oxide, having an average molar weight of 2250 (OHN=25)) at 100° C. for 30 minutes. Thereafter, at 70° C., 142.0 g of N-tert-butylbenzylamine are added over the course of 30 minutes at a rate such that the temperature of the reaction mixture does not exceed 75° C. The mixture is stirred at 75° C. until the theoretical NCO value has been reached. Over the course of 2 minutes a mixture of 27.5 g of the hydrophilicizing agent KV 1386 (BASF AG, Ludwigshafen, DE) and 46.8 g of water is metered in followed by stirring for 7 minutes at neutral temperature. Dispersing is then carried out, by addition of 761.3 g of water. After a subsequent stirring time of 4 hours a storage-stable aqueous dispersion is obtained having a solids content of 28.0%.

### Example 12

154.1 g of a biuret-group-containing polyisocyanate based on 1,6-diisocyanato-hexane (HDI), having an NCO content of 23.0%, are stirred with 6.3 g of polyether LB 25 (Bayer AG, Lev., DE, monofunctional polyether based on ethylene oxide/propylene oxide, having an average molar weight of 2250 (OHN=25)) at 100° C. for 30 minutes. Thereafter, at 90° C., 60.6 g of butanone oxime are added over the course of 20 minutes at a rate such that the temperature of the reaction mixture does not exceed 110° C. The mixture is stirred at 100° C. until the theoretical NCO value has been reached, and then cooled to 90° C. After a subsequent stirring time of 5 minutes, a mixture of 22.0 g of the hydrophilicizing agent KV 1386 (BASF AG, Ludwigshafen, DE) and 37.5 g of water is metered in over the course of 2 minutes followed by stirring for 7 minutes at neutral temperature. Dispersing is then carried out, by addition of 485.5 g of water. After a subsequent stirring time of 4 hours a storage-stable aqueous dispersion is obtained having a solids content of 29.8%.

### Example 13

963.0 g of a biuret-group-containing polyisocyanate based on 1,6-diisocyanato-hexane (HDI), having an NCO content of 23.0%, are stirred with 39.2 g of polyether LB 25 (Bayer AG, Lev., DE, monofunctional polyether based on ethylene oxide/propylene oxide, having an average molar weight of 2250 (OHN=25)) at 100° C. for 30 minutes. Thereafter, 493.0 g of ε-caprolactam are added over the course of 20 minutes at a rate such that the temperature of the reaction mixture does not exceed 110° C. The mixture is stirred at 110° C. until the theoretical NCO value has been reached, and then cooled to 90° C. After a subsequent stirring time of 5 minutes, a mixture of 152.5 g of the hydrophilicizing agent KV 1386 (BASF AG, Ludwigshafen, DE) and 235.0 g of water is metered in over the course of 2 minutes followed by stirring for 7 minutes at neutral temperature. Dispersing is then carried out, by addition of 3325.1 g of water. After a subsequent stirring time of 4 hours a storage-stable aqueous dispersion is obtained having a solids content of 30.0%.

### Example 14

99.12 g of PETIA (pentaerythritol triacrylate technical grade, from UCB GmbH, Kerpen, DE) and 9.45 g of 1,6-hexanediol were added at 70° C. with stirring to 343.20 g of an aliphatic polyisocyanate (Desmodur N 3300, Bayer AG, Leverkusen). At 70° C. a solution of 37.76 g of hydroxypivalic acid in 60.93 g of N-methylpyrrolidone was added dropwise over the course of 3 hours followed by stirring at 70° C. for 1 hour. Then, at 70° C., 108.48 g of diisopropylamine were added dropwise over the course of 60 minutes followed by stirring for 30 minutes. After this time, NCO groups were no longer detectable by IR spectroscopy. Then, with vigorous stirring, 883 g of hot deionized water at 70° C. were added and stirring was continued for 1 hour. Cooling to room temperature with stirring gave a dispersion having the following properties:

| | | |
|---|---|---|
| Solids content: | 40% | |
| Viscosity (23° C.): | 200 | mPas |
| Particle size (LCS): | 89 | nm |

### Example 15-17

Coating Compositions Comprising UV Curable Polyurethane Dispersions and Water-Dispersible Blocked Polyisocyanates for Use in or as Sizes

The compositions of the sizes are described in Tables 1-4. The mechanical properties of the coating composition or of the size were determined on free films produced as follows:

A film applicator consisting of two polished rolls which can be set an exact distance apart had a release paper inserted into it ahead of the back roll. The distance between the paper and the front roll was adjusted using a feeler gauge. This distance corresponds to the (wet) film thickness of the resulting coating, and can be adjusted for the desired application rate of any coating. It is also possible to carry out coating consecutively in two or more coats. To apply the individual coats, the products (aqueous formulations are adjusted beforehand to a viscosity of 4500 mPa s by addition of ammonia/polyacrylic acid) were poured onto the nip between the paper and the front roll, the release paper was pulled vertically downwards, the corresponding film being formed on the paper. Where two or more coats were to be applied, each individual coat was dried and the paper was reinserted.

The 100% modulus was determined in accordance with DIN 53504 on films with a thickness of >100 μm.

Film storage under hydrolysis conditions takes place in accordance with DIN EN 12280-3. The mechanical properties of these film samples were determined following 24 hours of storage under standard conditions (20° C. and 65% air humidity) in accordance with DIN 53504.

The UV curing operation was carried out on a UV curing station from IST (Nürtingen, DE) with a gallium-doped UV lamp (type CK 1) with an output of 80 W/cm lamp length at an advancing speed of 2.5 m/min.

The results of the tests of the mechanical properties of the free films demonstrate that with the coating composition set out above, depending on drying conditions, the various crosslinking mechanisms can be addressed selectively, separately from one another.

1^{st} Conditions (Comparative)

Drying at 20° C. for 45 minutes

Drying at 80° C. for 10 minutes

TABLE 1
500 μm wet film applied to release paper

| Composition | Example 15 | | Example 16 | | Example 17 | |
|---|---|---|---|---|---|---|
| UV PU dispersion | | | | | | |
| Example 1 [g] | 360.0 | | | | | |
| Example 2 [g] | | | 360.0 | | | |
| Example 3 [g] | | | | | 360.0 | |
| Polyisocyanate A | | | | | | |
| Example 12 [g] | 40.0 | | 40.0 | | 40.0 | |
| Irgacure 500 [g] | 2.8 | | 3.0 | | 3.0 | |
| Mixing ratio | 90:10 | | 90:10 | | 90:10 | |
| NVC of the mixture [%] | 34.4 | | 38 | | 37.7 | |
| Irgacure as portion of NVC | 2% | | 2% | | 2% | |
| | Preparation of the pastes | | | | | |
| Mixture [g] | 200.0 | | 200.0 | | 200.0 | |
| 25% Ammonia | 3 | ml | 2 | ml | 2 | ml |
| Mirox AM, 1:1 in H₂O | 3 | ml | 3.5 | ml | 2 | ml |
| | Tensile tests on free films | | | | | |
| 100% modulus [MPa] | 0.4 | | 0.5 | | 0.4 | |
| Tensile strength [MPa] | 0.5 | | 0.6 | | 0.6 | |
| Elongation at break [%] | 450 | | 590 | | 610 | |

| | | | |
|---|---|---|---|
| 14 d hydrolysis | film has run | film has run | film has run |
| Tensile strength [MPa] | | | |
| Elongation at break [%] | | | |

NVC = non-volatiles content
Mirox ® AM = thickener (Stockhausen, Krefeld, DE)

2^{nd} Conditions (Comparative)

Drying at 20° C. for 45 minutes

Drying at 80° C. for 10 minutes

Drying at 150° C. for 30 minutes

TABLE 2
500 μm wet film applied to release paper

| Composition | Example 15 | | Example 16 | | Example 17 | |
|---|---|---|---|---|---|---|
| UV PU dispersion | | | | | | |
| Example 1 [g] | 360.0 | | | | | |
| Example 2 [g] | | | 360.0 | | | |
| Example 3 [g] | | | | | 360.0 | |
| Polyisocyanate A | | | | | | |
| Example 12 [g] | 40.0 | | 40.0 | | 40.0 | |
| Irgacure 500 [g] | 2.8 | | 3.0 | | 3.0 | |
| Mixing ratio | 90:10 | | 90:10 | | 90:10 | |
| NVC of the mixture [%] | 34.4 | | 38 | | 37.7 | |
| Irgacure as portion of NVC | 2% | | 2% | | 2% | |
| | Preparation of the pastes | | | | | |
| Mixture [g] | 200.0 | | 200.0 | | 200.0 | |
| 25% Ammonia | 3 | ml | 2 | ml | 2 | ml |
| Mirox AM, 1:1 in H₂O | 3 | ml | 3.5 | ml | 2 | ml |
| | Tensile tests on free films | | | | | |
| 100% modulus [MPa] | 3 | | 3.1 | | 1.8 | |
| Tensile strength [MPa] | 4.3 | | 4.3 | | 3.8 | |
| Elongation at break [%] | 290 | | 270 | | 380 | |

| | | | |
|---|---|---|---|
| 14 d hydrolysis | film has run | film has run | film has run |
| Tensile strength [MPa] | | | |
| Elongation at break [%] | | | |

NVC = non-volatiles content
Mirox ® AM = thickener (Stockhausen, Krefeld, DE)

3^{rd} Conditions (Comparative)

Drying at 20° C. for 45 minutes

Drying at 80° C. for 10 minutes

UV drying: 2.5 m/min 80 W

TABLE 3
500 μm wet film applied to release paper

| Composition | Example 15 | | Example 16 | | Example 17 | |
|---|---|---|---|---|---|---|
| UV PU dispersion | | | | | | |
| Example 1 [g] | 360.0 | | | | | |
| Example 2 [g] | | | 360.0 | | | |
| Example 3 [g] | | | | | 360.0 | |
| Polyisocyanate A | | | | | | |
| Example 12 [g] | 40.0 | | 40.0 | | 40.0 | |
| Irgacure 500 [g] | 2.8 | | 3.0 | | 3.0 | |
| Mixing ratio | 90:10 | | 90:10 | | 90:10 | |
| NVC of the mixture [%] | 34.4 | | 38 | | 37.7 | |
| Irgacure as portion of NVC | 2% | | 2% | | 2% | |
| | Preparation of the pastes | | | | | |
| Mixture [g] | 200.0 | | 200.0 | | 200.0 | |
| 25% Ammonia | 3 | ml | 2 | ml | 2 | ml |
| Mirox AM, 1:1 in H₂O | 3 | ml | 3.5 | ml | 2 | ml |
| | Tensile tests on free films | | | | | |
| 100% modulus [MPa] | 5.6 | | 3.6 | | 3.4 | |
| Tensile strength [MPa] | 6.8 | | 4.4 | | 4.6 | |
| Elongation at break [%] | 120 | | 120 | | 130 | |
| 14 d hydrolysis | | | | | | |
| Tensile strength [MPa] | 11.7 | | 9.2 | | 9.2 | |
| Elongation at break [%] | 120 | | 130 | | 130 | |
| 4 week hydrolysis | | | | | | |
| Tensile strength [MPa] | 11.5 | | 9.3 | | 9.6 | |
| Elongation at break [%] | 100 | | 120 | | 130 | |
| 6 week hydrolysis | | | | | | |
| Tensile strength [MPa] | 11.9 | | 11.5 | | 11 | |
| Elongation at break [%] | 140 | | 160 | | 160 | |
| 8 week hydrolysis | | | | | | |
| Tensile strength [MPa] | 8.7 | | 7.7 | | 9.9 | |
| Elongation at break [%] | 140 | | 180 | | 160 | |
| 10 week hydrolysis | | | | | | |
| Tensile strength [MPa] | 5.9 | | 3.9 | | 8.1 | |
| Elongation at break [%] | 170 | | 210 | | 170 | |

NVC = non-volatiles content
Mirox ® AM = thickener (Stockhausen, Krefeld, DE)

4^{th} Conditions (Inventive)

Drying at 20° C. for 45 minutes

Drying at 80° C. for 10 minutes

Drying at 150° C. for 30 minutes

UV drying: 2.5 m/min 80 W

TABLE 4
500 μm wet film applied to release paper

| Composition | Example 15 | | Example 16 | | Example 17 | |
|---|---|---|---|---|---|---|
| UV PU dispersion | | | | | | |
| Example 1 [g] | 360.0 | | | | | |
| Example 2 [g] | | | 360.0 | | | |
| Example 3 [g] | | | | | 360.0 | |
| Polyisocyanate A” | | | | | | |
| Example 12 [g] | 40.0 | | 40.0 | | 40.0 | |
| Irgacure 500 [g] | 2.8 | | 3.0 | | 3.0 | |
| Mixing ratio | 90:10 | | 90:10 | | 90:10 | |
| NVC of the mixture [%] | 34.4 | | 38 | | 37.7 | |
| Irgacure as portion of NVC | 2% | | 2% | | 2% | |
| | Preparation of the pastes | | | | | |
| Mixture [g] | 200.0 | | 200.0 | | 200.0 | |
| 25% Ammonia | 3 | ml | 2 | ml | 2 | ml |
| Mirox AM, 1:1 in H₂O | 3 | ml | 3.5 | ml | 2 | ml |
| | Tensile tests on free films | | | | | |
| 100% modulus [MPa] | not | | not | | not | |
| | measurable | | measurable | | measurable | |
| Tensile strength [MPa] | 21 | | 19.1 | | 18.4 | |
| Elongation at break [%] | 50 | | 50 | | 50 | |
| 14 d hydrolysis | | | | | | |
| Tensile strength [MPa] | 16.8 | | 14.7 | | 15.4 | |
| Elongation at break [%] | 60 | | 60 | | 60 | |
| 4 week hydrolysis | | | | | | |
| Tensile strength [MPa] | 18 | | 17.6 | | 17 | |
| Elongation at break [%] | 50 | | 70 | | 50 | |
| 6 week hydrolysis | | | | | | |
| Tensile strength [MPa] | 16.5 | | 14.7 | | 18.1 | |
| Elongation at break [%] | 70 | | 70 | | 50 | |
| 8 week hydrolysis | | | | | | |
| Tensile strength [MPa] | 14.6 | | 11.7 | | 15.4 | |
| Elongation at break [%] | 90 | | 80 | | 70 | |
| 10 week hydrolysis | | | | | | |
| Tensile strength [MPa] | 11 | | 10.7 | | 12.8 | |
| Elongation at break [%] | 110 | | 110 | | 70 | |

NVC = non-volatiles content
Mirox ® AM = thickener (Stockhausen, Krefeld, DE)

All of the dispersions described in Examples 1-17 are suitable for use in sizes and exhibit excellent compatibility in particular with regard to aminosilanes such as aminopropyltriethoxysilane (A1100, Union Carbide, USA), for example. To test for A1100 compatibility, first of all a 10% strength aqueous solution with a pH of 5.5-6.5 (established using 10% strength acetic acid) is prepared. The A1100 solution prepared is introduced into a burette and 200 g of PU dispersion (from Examples 1-17) in a glass beaker are provided with magnetic stirrer rods and placed on a magnetic stirrer. The pH of the dispersion is measured, while stirring, 2 ml of A1100 solution are added dropwise, and measurement of the pH continues until a constant value is reached. The procedure is then repeated until 10% of the solution (calculated on the basis of the total amount of the PU dispersion) has been introduced into the PU dispersion. Following each addition of aminosilane A1100 solution, the pH is measured and recorded. Where incompatibility between PU dispersion and aminosilane A1100 is observed in the course of the addition, the test is terminated. Otherwise, the dispersion to which A1100 has been added is stored for 24 hours to allow observation of any subsequent changes such as formation of coagulum, for example. All of the dispersions described in Examples 1-17 passed the abovementioned compatibility test.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Method for preparing glass fiber reinforced plastics, comprising
(a) applying a sizing composition, comprising blocked polyisocyanate and water, to the glass fiber,
(b) removing the water,
(c) exposing the coated glass fiber to high-energy radiation
(d) introducing the coated glass fiber into a plastic; and
(e) carrying out a thermal cure at from 150 to 300° C., with liberation of the polyisocyanate groups by deblocking.

2. Method for preparing glass fiber reinforced plastics according to claim 1, wherein the sizing composition comprises
(I) at least one water-dispersible or water-soluble blocked polyisocyanate,
(II) at least one polyurethane which contains free-radically polymerizable groups and from 0 to 0.53 mmol of groups containing Zerevitinov-active hydrogen atoms, and
(III) an initiator which is capable of initiating a free-radical polymerization.

3. Method for preparing glass fiber reinforced plastics according to claim 1, wherein the blocked polyisocyanate is a reaction product of
(A1) at least one first precursor polyisocyanate containing aliphatically, cycloaliphatically, araliphatically and/or aromatically attached isocyanate groups,
(A2) at least one ionic or potentially ionic and/or nonionic compound, and
(A3) at least one blocking agent.

4. Process for preparing glass fiber reinforced plastics according to claim 1 wherein the polyurethane is a reaction product of
(a) one or more second precursor di- or polyisocyanates,
(b1) one or more hydrophilicizing compounds containing nonionic groups and/or ionic groups and/or groups which can be converted into ionic groups, and
(b2) one or more compounds containing free-radically polymerizable groups,

5. The method of claim 3, wherein the blocked polyisocyanate is further a reaction product of at least one of
(A4) one or more (cyclo)aliphatic mono- or polyamines having from 1 to 4 amino groups, from the molecular weight range from 32 to 300,
(A5) one or more polyhydric alcohols having from 1 to 4 hydroxyl groups, from the molecular weight range from 50 to 250, and
(A6) one or more compounds containing isocyanate-reactive and unsaturated groups.

6. The method of claim 4, wherein the polyurethane is further a reaction product of at least one of
(b3) one or more polyol compounds having an average molecular weight of from 50 to 500, and a hydroxyl functionality of greater than or equal to 2 and less than or equal to 3,
(b4) one or more polyol compounds having an average molecular weight of from 500 to 13000 g/mol, with an average hydroxyl functionality of from 1.5 to 2.5, and
(b5) one or more di- or polyamines.

7. The method of claim 4, wherein the polyurethane is further a reaction product of at least one of
(b3) one or more polyol compounds having an average molecular weight of from 80 to 200, and a hydroxyl functionality of greater than or equal to 2 and less than or equal to 3, and
(b4) one or more polyol compounds having an average molecular weight of from 700 to 4000 g/mol with an average hydroxyl functionality of from 1.8 to 2.2.

8. The method of claim 4, wherein the polyurethane is further a reaction product of one or more polyol compounds having an average molecular weight of from 500 to 13000 g/mol, with an average hydroxyl functionality of from 1.9 to 2.1,
